(19) United States
(12) Patent Application Publication
(10) Pub. No.: US 2015/0024135 A1
(43) Pub. Date: Jan. 22, 2015

(54) Marbleizing an Object

(71) Applicant: Richard Denney, Fayetteville, GA (US)

(72) Inventor: Richard Denney, Fayetteville, GA (US)

(21) Appl. No.: 13/944,079

(22) Filed: Jul. 17, 2013

(51) Int. Cl. B05D 5/06; B05D 7/00; B05D 1/20

(52) U.S. Cl. CPC B05D 5/061; B05D 1/20; B05D 7/53
USPC 427/281

(57) ABSTRACT

A method for coating an object with a design pattern is provided and includes placing a specified amount of water with no additives in a container to a depth exceeding at least one dimension of the object, adding a first acrylic paint to the water in an amount to provide a first layer of paint on the surface of the water, adding at least one additional acrylic paint to the water in an amount to provide at least one additional layer of paint on the surface of the water, mixing the combination of water and acrylic paints until the design pattern is present, dipping the object into the container so that the combination of water and acrylic paints covers the object beyond the at least one dimension of the object, and removing the object from the container so that the object is coated with the design pattern.

### BACKGROUND

The present disclosure pertains to methods for decorating articles with paints. More particularly, this disclosure pertains to methods for coating an object with a marbleized pattern by dipping the object in paints floating on water.

Applying a coating to the surface of solid materials is often performed by dipping the solid material into a type of liquid composition for applying a coating to the material. One traditional method for applying the coating material is to float the material on a second liquid so that a uniform layers is formed. Variations in the application of coatings have included additives to a water bath having a multiple oil color paint surface floating on the water. Adding materials to the water solution sometimes prevents flowing and fixes the paints in a particular orientation. Addition of various materials can also provide special visual effects, improved uniformity, and adhesion of the coating to the article.

Providing additives to the water however, shifts the focus further away from the artistic endeavor and can produce a wide variation in results that sometimes extend beyond the creativity of the decorator.

### BRIEF SUMMARY

According to one embodiment of the present disclosure, a method for coating an object with a design pattern, is provided that includes placing a specified amount of water in a container to a depth exceeding at least one dimension of the object to be coated, and wherein the water includes no additives, adding a first acrylic paint to the water in an amount to provide a first layer of paint on the surface of the water, adding at least one additional acrylic paint to the water in an amount to provide at least one additional layer of paint on the surface of the water, mixing the combination of water and acrylic paints within the container until the design pattern is present, dipping the object into the container so that the combination of water and acrylic paints covers the object beyond the at least one dimension of the object, and removing the object from the container so that the object is coated with the design pattern.

Another embodiment includes adding the at least one additional acrylic paint to the water within the outer edges of the first layer of paint.

Another embodiment includes adding the at least one additional acrylic paint to the water within the outer edges of any previously added layers of paint

Another embodiment includes submerging the entirety of the object within the container.

In another embodiment the mixing further includes stirring the combination of water and acrylic paints to form a pattern on the surface of the water.

In another embodiment the mixing further comprises swirling the combination of water and acrylic paints with a substantially linear object to form a pattern on the surface of the water.

In another embodiment the object to be coated is one of: a guitar, a skateboard, a surfboard.

Another embodiment includes dipping the object in the container further comprises applying a satin varnish to the object prior to dipping, where the object is a non-porous material.

Another embodiment includes applying a sealer to the object after removing the object from the container, wherein the sealer protects the design pattern on the object.

In another embodiment the at least one dimension comprises the largest dimension of the object.

According to another embodiment, a method for coating an object with a design pattern, is provided that includes placing a specified amount of water in a container to a depth sufficient to immerse the object to be coated, adding at least one acrylic paint to the water in an amount to provide at least one layer of paint on the surface of the water, mixing the water and the at least one acrylic paint within the container until the design pattern is present, dipping the object into the container so that the object is submerged beneath the water and the combination of water and acrylic paints covers the object, and removing the object from the container so that the object is coated with the design pattern.

Other systems, methods, features and advantages of the present invention will be or become apparent to one with skill in the art upon examination of the following drawings and detailed description. It is intended that all such additional systems, methods, features and advantages be included within this description and be within the scope of the present disclosure.

### BRIEF DESCRIPTION OF THE DRAWINGS

The above-mentioned features will become more clearly understood from the following detailed description read together with the drawings in which:

FIG. 1 is a flowchart illustrating a method for coating an object with a design pattern;

FIGS. 2-A, 2-B and 2-C together form an illustration showing the appearance of the water in a container at the various stages or steps for adding acrylic paint;

FIGS. 3-A, 3-B and 3-C together form an illustration showing the application of a design pattern coating to a guitar; and

FIGS. 4-A, 4-B and 4-C together form an illustration showing the application of a design pattern coating to a skateboard.

### DETAILED DESCRIPTION

A method for decorating articles by coating an object with a marbleized pattern by dipping the object in paints floating on water is disclosed. The marbleized pattern typically includes multiple colors.

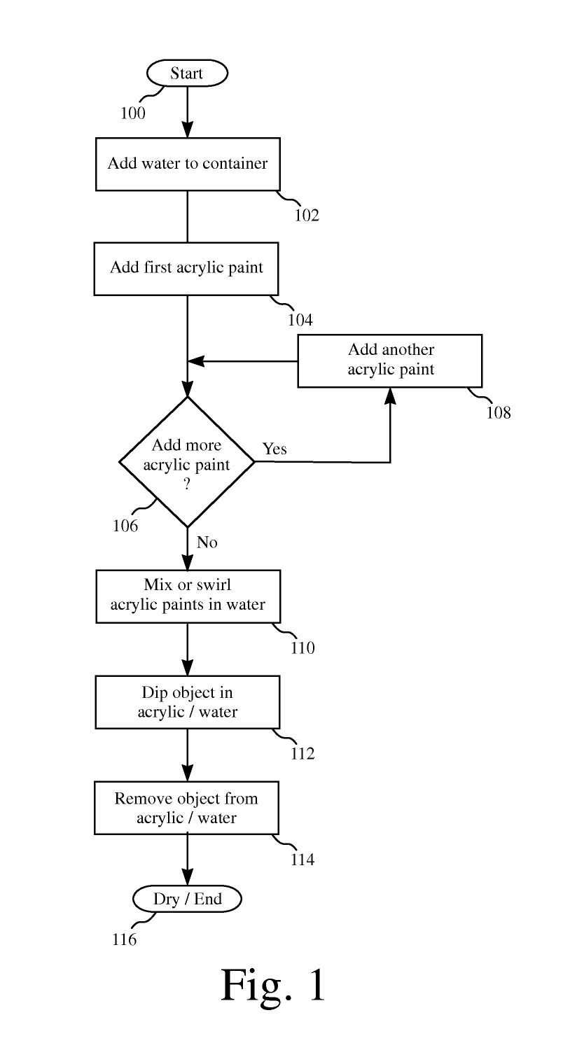

FIG. 1 is a flowchart illustrating a method 100 for coating an object with a design pattern. The process begins with adding water to a suitable container at step 102. Generally, a suitable container is one that provides for complete submersion of the object that is to be coated. Of course, variations in the objects to be coated allows for considerable variation in the container to be selected. For example, providing a coating for the body of a guitar while leaving the neck uncoated allows for using a container of sufficient size to cover only the body portion. Similar considerations should be factored into account for any object where only a portion of the object is to actually be coated. Smaller objects can be coated with similarly small containers while coating larger objects necessitates containers commensurate with the size of the object or the portion of the object to be coated. It is intended that the methods described herein include the capability for coating any sized object for which a sufficiently sized container is provided and for which the acrylic paints are suitable for coating.

Once a sufficient amount of water to provide for covering the object to be coated has been placed into the container, the acrylic paint should be added at step 104. Acrylic paint is a generally fast drying paint that contains pigment suspension in an acrylic polymer emulsion. They can be diluted with water but are very water-resistant when dry. Depending on dilution or other modifications, a final acrylic painted product can resemble a watercolor, an oil painting, or have its own unique characteristics. When an acrylic paint is dry, it is normally non-removable from a solid surface.

Artists have historically mixed their own paints to achieve the desired color, thickness, and other effects. Acrylic paints do not normally lend themselves to hand mixing due to the relatively rapid drying times. The appearance of acrylic paints can be modified by simply adding water. Adding water also affects the hardness, flexibility, texture, and other characteristics of the paint surface. Acrylics also bond to many different surfaces and provides a wide variation in color and properties.

Acrylics can be used on paper, canvas and many other materials. The use of acrylic paint on engineered woods and other surfaces having a porous nature can be problematic. In such cases the use of a sealer on the surface is generally beneficial. Acrylic paints are sometimes applied in thin layers to create watercolor and similar effects. Acrylic paints can also be used to create thick layers of paint.

In the present disclosure, the addition of acrylic paint to the water also provides for extending the time available for painting and/or coating of the desired objects. Once the acrylic paint is added to the water, it forms a thin layer that floats on the surface of the water. The thickness of the layer is dependent upon the amount of acrylic paint that is added and will, of course, affect the appearance of the resultant coating on the object.

Providing a marbleized coating to an object typically requires that multiple colors be used. However, the present method also provides for coating an object in a single color or in a color diluted somewhat by the water into which it has been added. Therefore, a determination is made whether additional acrylic paint should be added to the mix at step 106. If more acrylic paint is needed or desired, then it is added at step 108. The additional acrylic paint can be a different color or more of the same color, as necessary for the particular design pattern. Once the additional acrylic paint has been added, the process returns again to step 106 for a determination whether additional acrylic paint should be added or whether no more paint is needed.

Once the addition of acrylic paint to the water is complete, adjustments to the appearance of the mixture can be made at step 110. The appearance of the acrylic paint layers on the surface of the water will depend greatly on the manner in which the paint is added to the water. In various embodiments, the paint is added via drop tips that attach to the bottles in which the paint is normally provided. Such drop tips are typically provided in various sizes such as 20 ml, 30 ml, and 60 ml. Of course, the sizes for the drop tips can vary according to the provider of the acrylic paints that are used. One such provider is HobbyLine in Hallerndorf, Germany that provides a Magic Marble acrylic paint that is suitable for the methods described herein. The Magic Marble acrylic paints are available in more than 50 base colors, as well as more than 15 metallic colors and at least three glitters at the time of this application. It is of course, expected that the number of available acrylic paint types and colors will increase over time. The Magic Marble paints are lead-free and conform to applicable safety and toxicology standards.

In one embodiment, a first amount of a first acrylic paint is added via drop tips to the water. The acrylic paint then spreads out into a thin layer on the surface of the water. A second amount of a second acrylic paint is then added via drop tips and within the outer edges of the first layer. The first color is displaced to some degree by the second color. In this way, the second color will typically be more vibrant than the first color on the coated object. In various embodiments, additional colors can be added as desired to produce a multi-colored design pattern. Additionally, the colors can be added by providing successive acrylic paints within the outer edges of the previous paint, or alternatively, the colors can be added by providing successive acrylic paints at differing locations within the previously applied layers.

Once the specific acrylic paints are present on the surface of the water, the paints are typically mixed or swirled in some manner to provide for variations in the marbling effect. The swirling or mixing is typically performed by using a stirring device. Such a stirring device can vary in size from a toothpick to a large stifling stick. Of course, the amount of stirring will affect the resulting marbling pattern. For larger objects it is envisioned that a larger stifling object will provide greater variation in the design pattern produced, while a smaller stirring object will typically provide for more subtle effects. Of course, the vigorousness with which the paint layers are stirred or swirled will significantly affect the marbling pattern.

After the acrylic paints have been stirred or mixed, the preparation is ready for an object to be immersed in the water at step 112. Typically, the object will be dipped until the portion to be coated is completely immersed under the surface of the water. This allows for a complete coating of that portion of the object. The object is then withdrawn from the water at step 114 and includes a thin layer of the marbling design pattern according to the mixture of acrylic paints used.

Once the object is removed from the water, then the object is allowed to dry at step 116 which normally ends the coating process. Acrylic paints normally dry very quickly. A dry time of 30 to 60 minutes is typically sufficient for touch, though a dry time of up to 24 hours is sometimes necessary to provide best results for use of the coated object. The time required for sufficient drying will vary according to the material that is coated and also with the size of the coated object.

It should be noted that certain type items and/or materials will provide better results when coated with primers or sealers prior to being submerged in the acrylic paint and water coating solution. Similarly, some materials will provide better results and/or protection of the coating by applying a sealer to protect the design pattern after submission. Wait time after removal from the coating solution will vary according to the material and/or objects that are coated.

Coating via the described method is applicable glass, metal, plastics, fiberglass and other such smooth surfaces. For best results, the surface should be cleaned and prepared for the application of the coating. In some embodiments a base coating of a satin varnish or similar material should be applied prior to submerging the object in the coating solution.

Single color marbling effects can be obtained by using a colorless marbling paint along with the desired color.

Once the acrylic paints have been added to the water, the remainder of the coating process including dipping and withdrawal can be finished in as little as two to three minutes for some objects. Of course, the size of the object being coated will affect the time that should be allowed.

It should also be noted that the disclosed process for coating an object with a marbleized pattern can be applied to exemplary items that include jewelry such as beads, bracelets, and necklaces, as well as candles, vases, glassware, picture frames and other decorative items. Additionally, the coating is suitable for application to guitars, skateboards, surfboards, snowboards, bicycles, helmets, welding hoods and hard hats, motorcycle and bicycle parts, and tennis rackets. The coating is suitable for wearable items such as boots, shoes, sunglasses, some types of clothing, head bands and flip flops. Other usable items that can also be marbleized using the disclosed method include cell phone and smart phone cases, computer and laptop cases and coverings, guns, knives, bows and the like. Additional items that can be marbleized using the described methods include plastics of all kinds, Christmas ornaments, musical instruments including at least drums, pianos, amplifiers and the like, as wells as vehicles, signage of all kinds, art venues, banners, and home furnishings of all kinds including tables, lamps, and clocks. As evident from the above provided listing, the materials to which the described methods can be applied are numerous.

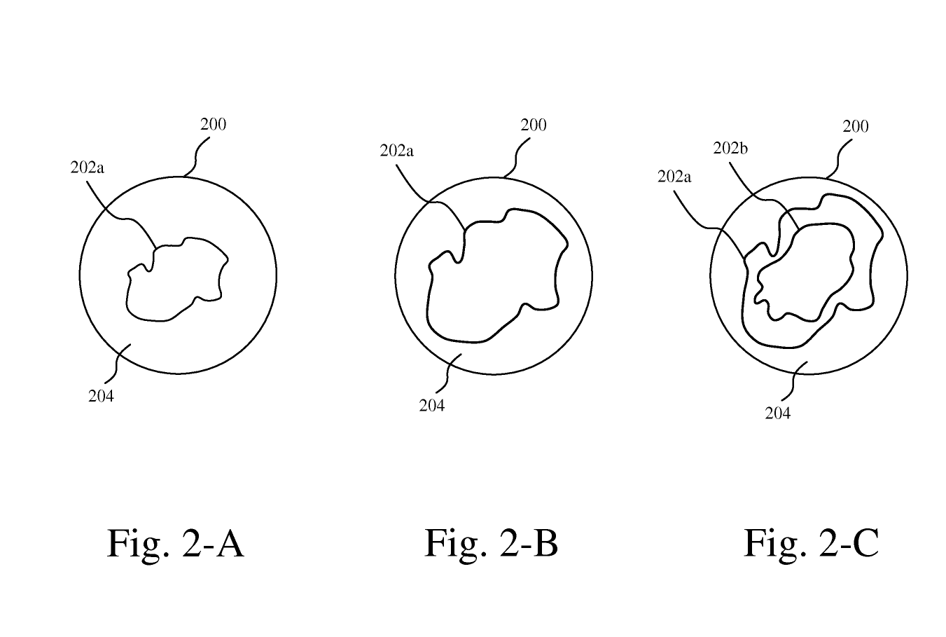

FIGS. 2-A, 2-B and 2-C together form an illustration showing the appearance of the water in a container at the various stages or steps for adding acrylic paint discussed above. FIG. 2-A shows a view of the container from the top and substantially filled with water. The first acrylic paint 202a has been added to the water and has partially dispersed along the surface of the water 204.

FIG. 2-B shows the container 200 after the first acrylic paint 202a has dispersed further across the surface of the water 204. Of course, the actual dispersal will vary according to the amount of the first acrylic paint 202a that is added, and also according to the conditions or other contents of the water 204 itself.

FIG. 2-C shows the container 200 after a second acrylic paint 202b has been added. In the illustrated embodiment, the second acrylic paint 202b has been added within the outer edges of the first acrylic paint 202a. The second acrylic paint 202b has partially dispersed toward the outer edges of the first acrylic paint 202a. It should be noted that the actual dispersal of both the first acrylic paint 202a and the second acrylic paint 202b will vary according to the actual amounts of the acrylic paints 202a, 202b (collectively 202) that are added to the surface of the water 204 within the container 200.

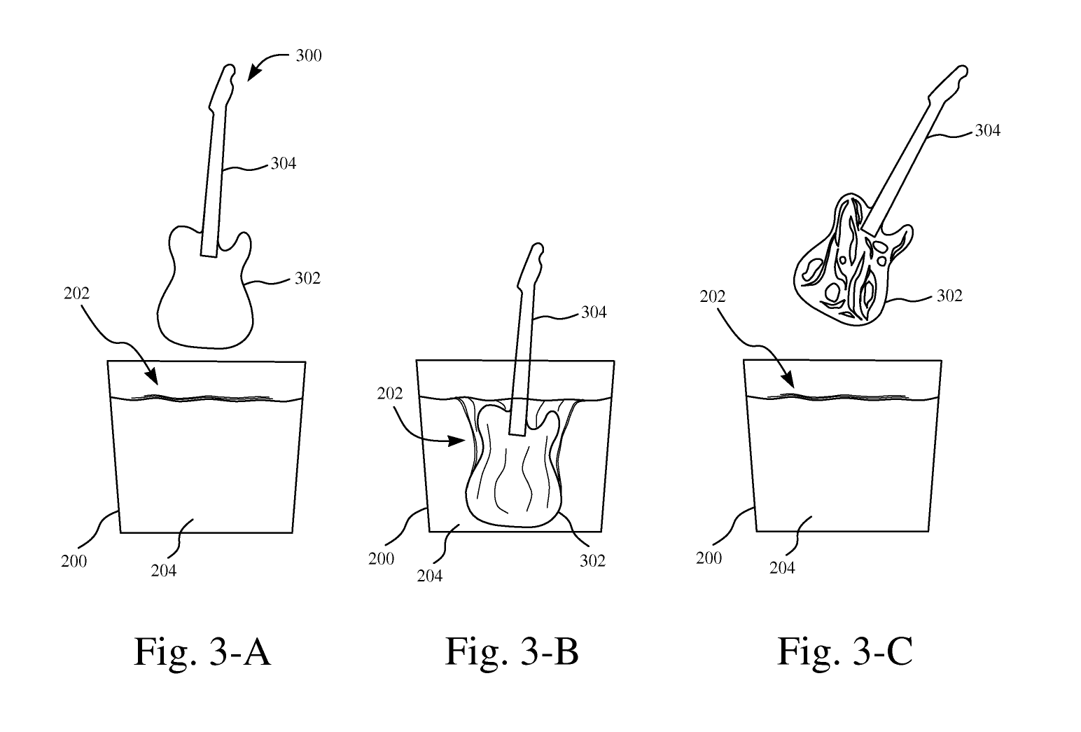

FIGS. 3-A, 3-B and 3-C together form an illustration showing the application of a design pattern coating to a guitar 300. In the illustrated embodiment, only the body 302 portion of the guitar 300 is dipped or submerged within the coating solution that is formed by the addition of acrylic paints 202 to the water 204. FIG. 3-A illustrates a container 200 substantially filled with water 204. In the illustrated embodiment, the container 200 includes a depth of water 204 to cover the body 302 of the guitar 300 when completely submerged. That is, the body 302 of the guitar 300 will be completely submerged beneath the surface of the water 204 when dipped for coating. It should also be noted that the illustrated embodiment illustrates that the acrylic paints 202 together form a layer along the surface of the water 204.

The body 302 of the guitar 300 is submerged within the coating solution of water 204 and acrylic paints 202 as illustrated in FIG. 3-B. As shown, the layer of acrylic paints 202 bonds to the surface of the guitar body 302 as it is submerged beneath the surface of the water 204.

Once the guitar body 302 is withdrawn or removed from the water 204, a marbling pattern is clearly visible on the body 302. Of course, the remaining acrylic paints 202 are again present along the surface of the water 204 and is ready for another object to be dipped into the water 204.

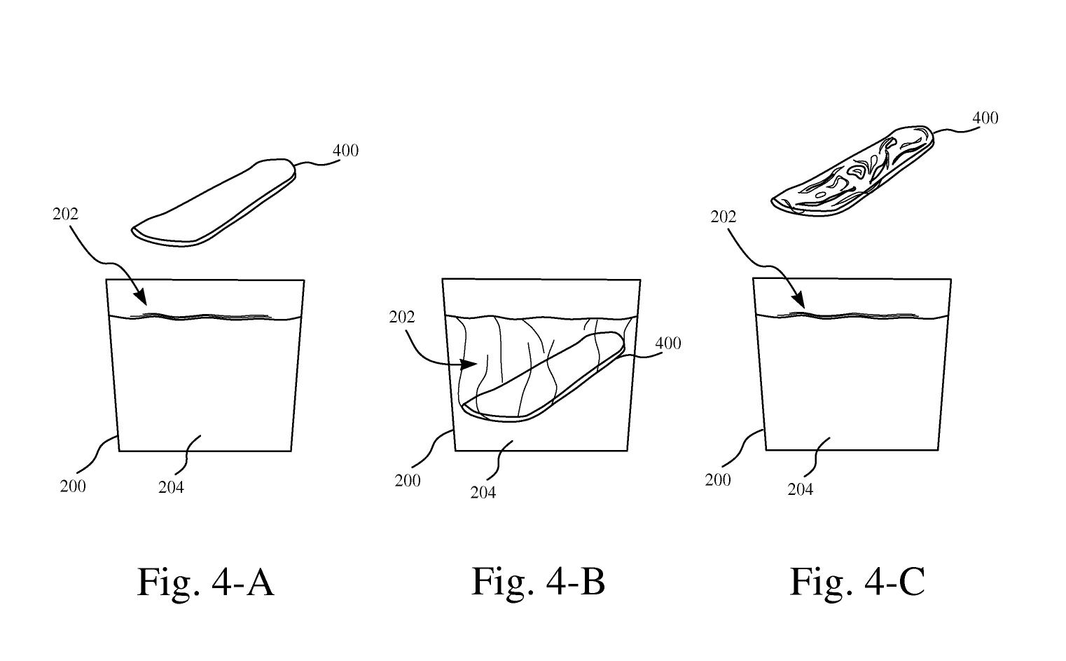

FIGS. 4-A, 4-B and 4-C together form an illustration showing the application of a design pattern coating to a skateboard 400. In the illustrated embodiment, the entire skateboard 400 is dipped or submerged within the coating solution that is formed by the addition of acrylic paints 202 to the water 204. FIG. 4-A illustrates a container 200 substantially filled with water 204. In the illustrated embodiment, the container 200 includes a depth of water 204 to cover the skateboard 400 when completely submerged. That is, the entirety of the skateboard 400 will be completely submerged beneath the surface of the water 204 when dipped for coating. As noted above, the illustrated embodiment shows the acrylic paints 202 together as a layer along the surface of the water 204.

The skateboard 400 is submerged within the coating solution of water 204 and acrylic paints 202 as illustrated in FIG. 4-B. As shown, the layer of acrylic paints 202 bonds to the surface of the skateboard 400 as it is submerged beneath the surface of the water 204.

Once the skateboard 400 is withdrawn or removed from the water 204, a marbling pattern is clearly visible on the skateboard 400. Of course, the remaining acrylic paints 202 are again present along the surface of the water 204 and is ready for another object to be dipped into the water 204.

The methods disclosed in the present application provide for using individual acrylic paints, paint kits, and containers of all size for adding marbleized coating to glass, wood, plastic, metals, alloys, fiberglass, paper and plastic. It is generally expected that the container will be of sufficient size and depth to allow for enough water to exceed at least one dimension of the object to be submerged into the water. That is, the depth of water will typically exceed the least dimension of the object to be coated. In some embodiments, the entirety of the object is submerged into the water for coating. In one embodiment, multiple colors are mixed into water that contains no additives. That is, nothing need be added to the water for this process to provide marbleized coatings to objects that are subsequently dipped into the water. The acrylic paints that are added to the water can be swirled and/or mixed to generate a unique design or pattern on the surface of the water.

Those skilled in the art will recognize that a method for coating an object with a design pattern, that includes placing a specified amount of water 204 in a container 200 to a depth exceeding at least one dimension of the object to be coated, and wherein the water 204 includes no additives, adding a first acrylic paint 202a to the water in an amount to provide a first layer of paint on the surface of the water 204, adding at least one additional acrylic paint 202b to the water 204 in an amount to provide at least one additional layer of acrylic paint on the surface of the water 204, mixing the combination of water 204 and acrylic paints 202 within the container 200 until the design pattern is present, dipping the object into the container 200 so that the combination of water 204 and acrylic paints 202 covers the object beyond the at least one dimension of the object, and removing the object from the container 200 so that the object is coated with the design pattern has been provided.

It should be emphasized that the above-described embodiments of the present disclosure are merely possible examples of implementations set forth for a clear understanding of the principles of the disclosure. Many variations and modifications may be made to the above-described embodiment(s) without departing substantially from the spirit and principles of the disclosure. All such modifications and variations are intended to be included herein within the scope of this disclosure and protected by the following claims.

What is claimed is:

1. A method for coating an object with a design pattern, the method comprising:
placing a specified amount of water in a container to a depth exceeding at least one dimension of the object to be coated, the specified amount of water being without additives;
adding a first acrylic paint to the water in an amount to provide a first layer of paint on the surface of the water;
adding at least one additional acrylic paint to the water in an amount to provide at least one additional layer of paint on the surface of the water;
mixing the combination of water and acrylic paints within the container until the design pattern is present;
dipping the object into the container so that the combination of water and acrylic paints covers the object beyond the at least one dimension of the object; and
removing the object from the container so that the object is coated with the design pattern.

2. The method of claim 1, further comprising adding the at least one additional acrylic paint to the water within the outer edges of the first layer of paint.

3. The method of claim 2, further comprising adding the at least one additional acrylic paint to the water within the outer edges of any previously added layers of paint.

4. The method of claim 1, further comprising submerging the entirety of the object within the container.

5. The method of claim 1, wherein the mixing further comprises stirring the combination of water and acrylic paints to form a pattern on the surface of the water.

6. The method of claim 1, wherein the mixing further comprises swirling the combination of water and acrylic paints with a substantially linear object to form a pattern on the surface of the water.

7. The method of claim 1, wherein the object to be coated is one of: a guitar, a skateboard, a surfboard.

8. The method of claim 1, wherein dipping the object in the container further comprises applying a satin varnish to the object prior to dipping, where the object is a non-porous material.

9. The method of claim 1, further comprising applying a sealer to the object after removing the object from the container, wherein the sealer protects the design pattern on the object.

10. The method of claim 1, wherein the at least one dimension comprises the largest dimension of the object.

11. A method for coating an object with a design pattern, the method comprising:
placing a specified amount of water in a container to a depth sufficient to immerse the object to be coated;
adding at least one acrylic paint to the water in an amount to provide at least one layer of paint on the surface of the water;
mixing the water and the at least one acrylic paint within the container until the design pattern is present;
dipping the object into the container so that the object is submerged beneath the water and the combination of water and acrylic paints covers the object; and
removing the object from the container so that the object is coated with the design pattern.

12. The method of claim 11, further comprising adding at least one additional acrylic paint to the water within the outer edges of the at least one layer of paint.

13. The method of claim 12, further comprising adding the at least one additional acrylic paint to the water within at least one outer edge of any previously added layers of paint.

14. The method of claim 11, wherein the mixing further comprises stirring the combination of water and acrylic paints to form a pattern on the surface of the water.

15. The method of claim 11, wherein the mixing further comprises swirling the combination of water and acrylic paints with a substantially linear object to form a pattern on the surface of the water.

16. The method of claim 11, wherein the object to be coated is one of: a guitar, a skateboard, a surfboard.

17. The method of claim 11, wherein dipping the object in the container further comprises applying a satin varnish to the object prior to dipping, where the object is a non-porous material.

18. The method of claim 11, further comprising applying a sealer to the object after removing the object from the container, wherein the sealer protects the design pattern on the object.

19. The method of claim 1, wherein the specified amount of water includes no additives.
